(19) United States
(12) Patent Application Publication
(10) Pub. No.: US 2004/0003215 A1
(43) Pub. Date: Jan. 1, 2004

(54) Method and apparatus for executing low power validations for high confidence speculations

(76) Inventors: Evgeni Krimer, Eilat (IL); Bishara Shomar, Nazareth (IL); Ronny Ronen, Haifa (IL); Doron Orenstein, Haifa (IL)

Correspondence Address: Kenyon & Kenyon, Suite 600, 333 W. San Carlos Street, San Jose, CA, 95110, US

(21) Appl. No.: 10/187,010

(22) Filed: Jun. 28, 2002

(51) Int. Cl. G06F 9/00

(52) U.S. Cl. 712/235; 712/239

(57) ABSTRACT

A method and apparatus for executing low power validations for high confidence predictions. More particularly, the present invention pertains to using confidence levels of speculative executions to decrease power consumption of a processor without affecting its performance. Non-critical instructions, or those instructions whose prediction, rather than verification, lie on the critical path, can thus be optimized to consume less power.

### BACKGROUND OF THE INVENTION

The present invention pertains to a method and apparatus for executing low power validations for high confidence predictions. More particularly, the present invention pertains to using confidence levels of speculative executions to decrease power consumption of a processor without affecting its performance.

As is known in the art, speculation is used throughout computer systems to improve performance. Speculation is a fundamental tool in computer architecture. It allows an architectural implementation to achieve higher instruction level parallelism and improve its performance by predicting the outcome of specific events. Most processors currently implement branch prediction to permit speculative control-flow. Based on a speculative branch prediction, the program counter is changed to point to a forward or backward instruction address. The outcome of data and control decisions is predicted, and the operations are speculatively executed and only committed if the original predictions were correct. More recent work has focused on predicting data values to reduce data dependencies.

Processors commonly predict conditional branches and speculatively execute instructions based on the prediction. In the prior art, typically when a speculation is used, all branches are predicted because there is a low penalty for speculating incorrectly. In those systems, most resources available to speculate would be used, and the branch prediction will be correct a high percentage of the time. As the use of speculation increases, the balance between the benefits of speculation with other possible activities becomes an important factor in the overall performance of a processor. With the advancement in current processor architecture designs, incorrect speculation may induce an unacceptable penalty on overall execution performance. From an energy consumption perspective, any incorrect speculation is wasteful.

Confidence estimation is one technique that can be exploited for speculation control. Confidence estimation is a technique for assessing the quality of a particular prediction. Modern processors come close to executing as fast as true dependencies allow. The particular dependencies that constrain execution speed constitute the critical path of execution. Formally, a critical path is the longest path in an execution graph, where an execution graph consists of executed instructions as nodes, and data dependencies and resource dependencies as weighted edges. The weight of each edge represents the time it takes to resolve the specific dependency. To optimize the performance of the processor, the critical path of execution should be reduced. Knowing the actual instructions that constitute the critical path is essential to achieve this performance optimization.

The performance of the processor is thus determined by the speed at which it executes the instructions along this critical path. Even though some instructions are more harmful to performance than others, current processors employ egalitarian policies: typically, a load instruction, a cache miss, and a branch misprediction are treated as costing an equal number of cycles. As a result, bottleneck-causing instructions are not focused on as being critical to performance, simply due to the difficulty of identifying the effective cost of the instruction. An article by Fields et al. discusses processor performance through the critical path. (Focusing Processor Policies via Critical-Path Prediction. Proceedings of the 28^{th} International Symposium on Computer Architecture. IEEE, Jul. 2001.) By knowing which instructions are critical to performance, current processors can perform an accelerated execution at the expense of instructions not on the critical path.

Current processors are optimized for speed and therefore execute all instructions, whether critical or not, with the maximum power available, without concern for energy or power consumption. A general demand exists for the ability to reduce the power consumption of a processor without affecting its overall performance. Further, reducing the levels of power consumed correspondingly reduces the heat generated by such processors, thereby addressing another obstacle to future increases in overall processor speed and performance.

In view of the above, there is a need for a method and apparatus for executing low power validations for high confidence predictions.

### BRIEF DESCRIPTION OF THE DRAWINGS

FIG. 1 is a block diagram of a portion of a speculative processor system employing an embodiment of the present invention.

FIG. 2 is a graph of the dependencies between instructions utilized in a dependence-graph model.

FIG. 3 is a flow diagram showing an embodiment of a method according to an embodiment of the present invention.

### DETAILED DESCRIPTION OF THE DRAWINGS

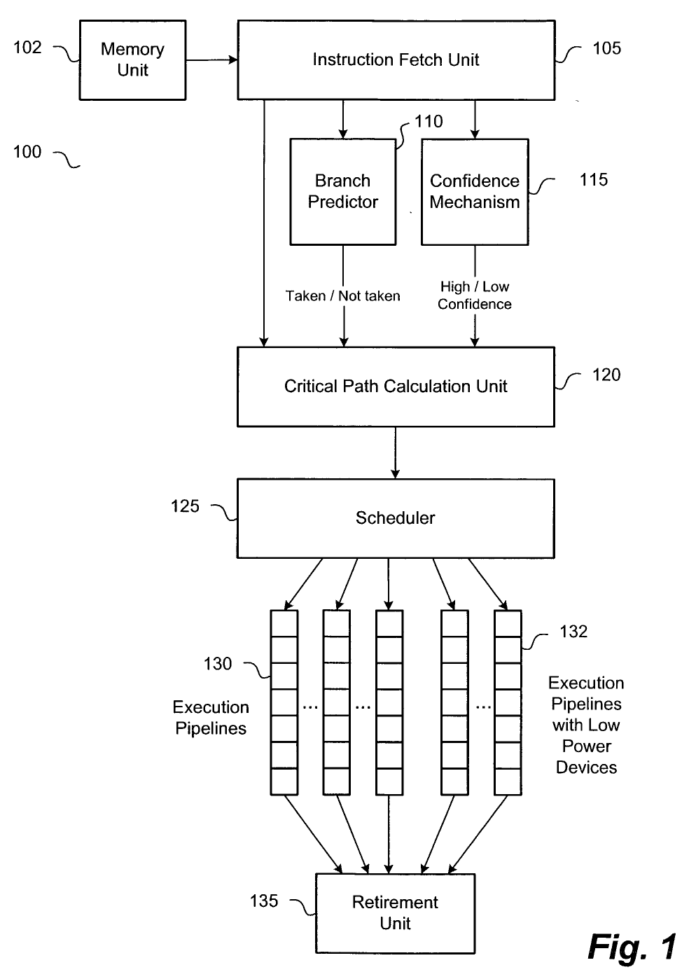

Referring to FIG. 1, a block diagram of a portion of a speculative processor system 100 (e.g. a microprocessor, a digital signal processor, or the like) employing an embodiment of the present invention is shown. In this embodiment of the processor system 100, instructions are fetched by a fetch unit 105 from memory 102 (e.g. from cache memory or system memory). Conditional branch predictions are then supplied to a predictor 110 paired with a confidence mechanism 115, in parallel. In this embodiment, predictor 110 is implemented as a branch predictor. As is known in the art, predictors can perform various types of speculative execution (e.g. branch prediction, data prediction, and other types of prediction). Confidence mechanism 115 generates a signal simultaneously with a branch prediction to indicate the confidence set to which the prediction belongs (e.g. a binary signal representing low or high confidence). In general, one skilled in the art will appreciate that the confidence sets may be divided into multiple sets with a range of confidence levels. Such multilevel signals (two or more) can be generated to provide even greater discretion in determining energy consumption levels for various instructions.

Several techniques for assigning confidence to branch predictions as well as a number of uses for confidence estimation are discussed by Jacobsen et al. (Assigning Confidence to Conditional Branch Predictions. Proceedings of the 29^{th} Annual International Symposium on Microarchitecture, pp. 142-152, December 1996.). Conditional branches are quite frequent in most modern processor architectures. With IA 32(Intel® Architecture—32-bits) processors manufactured by Intel Corporation, Santa Clara, Calif., greater than ten percent of all instructions are conditional branches, with more than ninety percent of branches coming immediately after the instruction that produces the flag values that indicate the result of the instruction (e.g. the compare instruction). In other ISAs (Instruction Set Architectures), the conditional branch and the compare instruction (or unit operating procedure) can be fused as a single instruction. In either case, when the branch prediction is of a high confidence level, it is likely that the instruction fetch unit 105 will fetch the right path. The compare and the jump instructions for the branch prediction still have to be properly executed in order to validate this prediction, but this validation process can be optimized for power rather than performance. Because the validation of the prediction does not lie along the critical path, the execution may be performed in low energy consumption devices, and thus, results in a slower execution that does not impact overall performance. Otherwise, in the case of an incorrect prediction, if the verification is run in a low power device (i.e. a slower execution), overall performance would be significantly degraded. By limiting those instructions that run on low power devices to non-critical instructions, that is, instructions not along the critical path, energy consumed by the processor is reduced without compromising execution performance.

Predicted instructions paired with a high confidence signal are forwarded to critical path calculation unit 120. Critical path calculation unit 120 makes determinations including how many clock cycles the instructions will take, the true dependencies required by the prediction (i.e. the instructions that the speculative instruction is dependent on) and the data paths to these instructions, and when to execute the group of instructions. Critical path calculation unit 120 forwards this critical path information with the branch prediction and its true dependencies to scheduler 125 to be executed in the low power devices in execution pipelines 132 (e.g. circuits that operate at a slower clock or operate at a lower voltage than execution pipelines 130). The outputs of execution pipes 132 are then supplied to the commit and retirement unit 135. One skilled in the art will appreciate that the critical path calculation unit 120 may be incorporated into the scheduler 125 either as a unit within the scheduler 125 or single-unit scheduler capable of the same calculations as critical path calculation unit 120.

When the branch prediction is paired with a low confidence signal, verification is more likely to be on the critical path, and thus, must be expedited in order to avoid possible performance degradation. These low confidence predictions are sent to critical path calculation unit 120 for dependency and critical path determinations for expediting verification. These determinations include the dependencies the predictions require to be executed, the address the instructions are located at, and the time, in core clock cycles, to execute the instructions. The branch prediction and dependencies along with these determinations are forwarded for use by scheduler 125. The instructions are executed in a normal manner, optimized for speed, in execution pipelines 130. The outputs of execution pipes 130 are then supplied to retirement unit 135 for commitment.

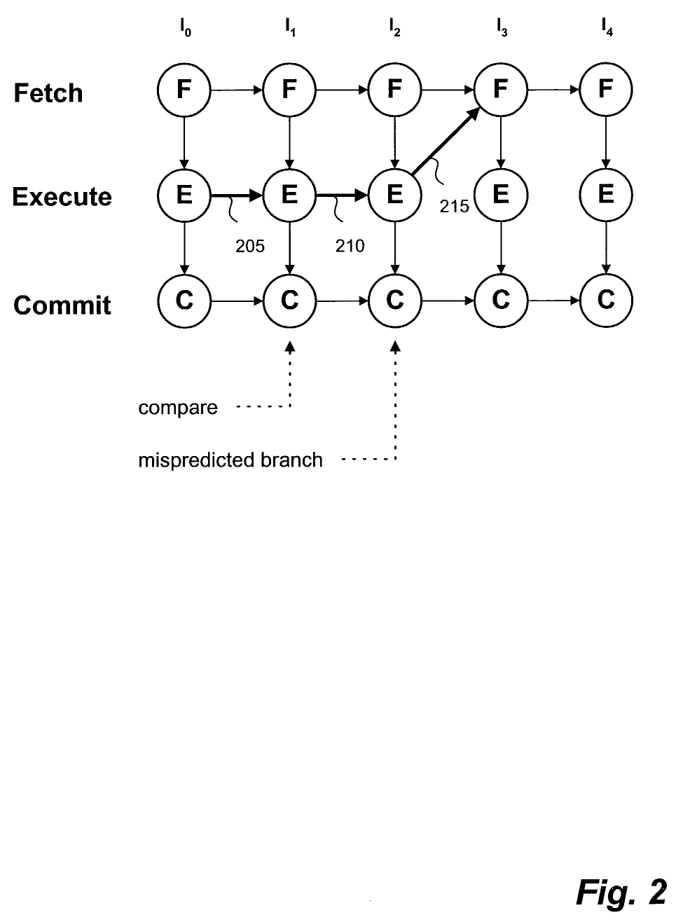

Referring to FIG. 2, a graph of the dependencies between instructions utilized in the dependence-graph model is shown. Fields et al. thoroughly discusses the development and usage of the dependence-graph model. In this example shown in FIG. 2, a compare instruction and mispredicted branch is shown along the critical path (the weighted path partially shown). Typically, the critical path is the longest weighted path shown on the graph. A set of dynamic instructions I₀ to I₄ are shown with data dependencies 205 and 210 and control dependency 215 represented by the bolded edges. Data dependencies 205 and 210 connect execute nodes, and a resource dependence due to a mispredicted branch induces an edge (control dependency 215) from the execute node of the branch to the fetch node of the correct target of the branch.

In traditional control/data flow analysis, the compare and branch instructions are on the critical path. Using the dependence-graph model (as shown in FIG. 2) as demonstrating an embodiment of this invention, a high confidence prediction likely removes control dependency 215 from the critical path. Furthermore, a high confidence level data prediction would potentially remove data dependencies 210 and 205. Therefore, a high confidence level prediction can be verified through execution in a low energy or low power consumption execution unit. However, if the prediction is wrong, the mispredicted branch requires following dependency 215 and the data dependencies from I₀ and I₁ along the critical path. Slowing them down will slow the execution, thereby decreasing overall processor performance. With a low level confidence prediction, the branch prediction and potentially the compare and previous instructions become critical and should be executed in a speed-optimized fashion. Thus, non-critical instructions can be run slower to consume less power without any overall slowdown in execution speed. In particular, when applying this to those instructions whose prediction, rather than verification, lie on the critical path, the execution (i.e. verification of the prediction) can be optimized to run slower to consume less power without impairing performance.

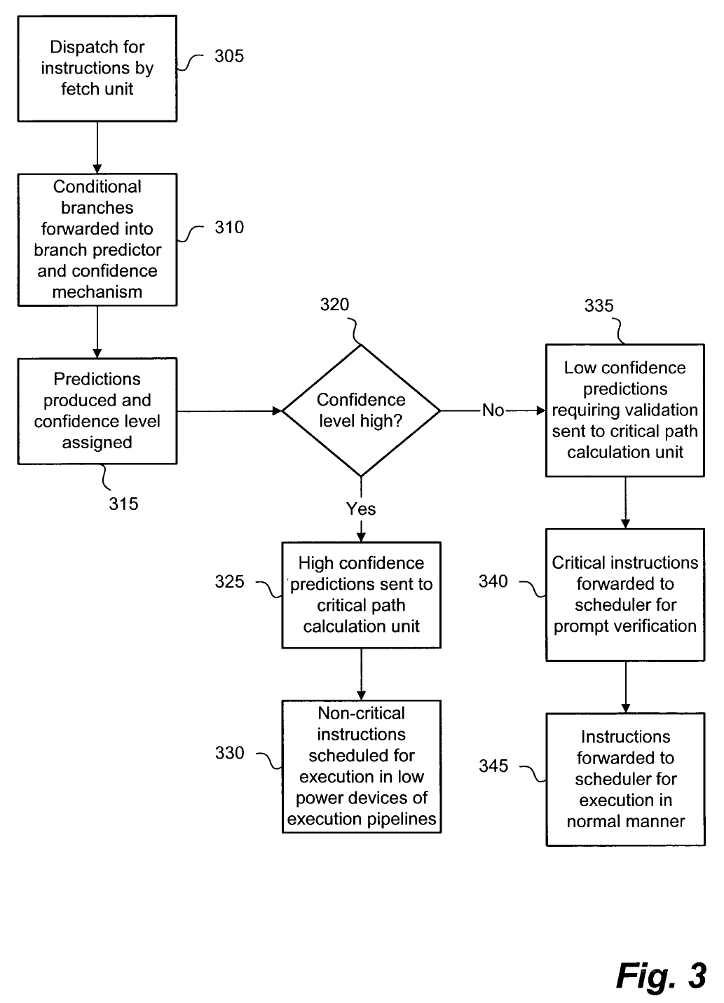

Referring to FIG. 3, a flow diagram of an embodiment of a method according to an embodiment of the present invention is shown. An example of the operation of speculative processor system 100 in this embodiment is shown in FIG. 3. In block 305, instruction fetch unit 105 dispatches for instructions from memory. Conditional branch predictions are filtered and, in block 310, are forwarded to branch predictor 110 and confidence mechanism 115 where a prediction is produced and a signal is generated for the confidence level for the corresponding prediction, in block 315. In decision block 320, after a confidence level is assigned, it is determined whether the prediction is of a low or high confidence level. If the prediction is of high confidence, control passes to block 325 where the predictions are forwarded to the critical path calculation unit 120. In critical path calculation unit 120, the prediction and its dependencies are determined as well as other information necessary for scheduler 125 to execute the instructions in low power. Control passes to block 330 where these determinations, including the high confidence prediction and its dependencies, are forwarded to scheduler 125. The instructions are then placed in the low power devices of execution pipelines 132.

If a low confidence prediction results, block 320 passes control to block 335. In block 335, these low confidence predictions are sent to critical path calculation unit 120. With the validation of the prediction likely on the critical path, critical path calculation unit 120 makes determinations necessary to verify the probable misprediction promptly. In block 340, the prediction and dependencies, along with these determinations, are sent to scheduler 125. Control passes to block 345 where scheduler 125 prepares instructions for execution in execution pipelines 130 in a normal manner to expedite verification of low confidence level predictions.

Although a single embodiment is specifically illustrated and described herein, it will be appreciated that modifications and variations of the present invention are covered by the above teachings and within the purview of the appended claims without departing from the spirit and intended scope of the invention.

What is claimed is:

1. A method of processing a speculative instruction in a processing system, comprising:
determining a confidence level for said speculative instruction; and
scheduling said speculative instruction for execution in a low power device of said processing system.

2. The method of claim 1 wherein said confidence level is high.

3. The method of claim 2 wherein determining a confidence level for said speculative instruction includes generating a binary signal for attachment to said speculative instruction.

4. The method of claim 3 further comprising:
determining whether said speculative instruction is in a critical path of a set of instructions;
determining a set of dependent instructions for execution with said speculative instruction; and
executing said set of dependent instructions and said speculative instruction in said low power device.

5. The method of claim 4 wherein said low power device is an execution pipeline optimized for low power consumption.

6. The method of claim 5 wherein said speculative instruction is a branch prediction.

7. The method of claim 5 wherein said speculative instruction includes a data dependency.

8. A method of executing a speculative instruction in a processing system, comprising:
determining a confidence level for said speculative instruction;
determining whether said speculative instruction is in a critical path of said set of instructions;
determining a set of dependencies of said speculative instruction; and
executing said speculative instruction and said set of dependencies in a set of execution pipes based on said confidence level and critical path.

9. The method of claim 8 wherein determining a confidence level for said speculative instruction includes generating a binary signal for attachment to said speculative instruction.

10. The method of claim 9 wherein said confidence level is high.

11. The method of claim 10 wherein said high confidence level is assigned to a set of low power execution pipes optimized for low power consumption.

12. The method of claim 9 wherein said confidence level is low.

13. The method of claim 12 wherein said high confidence level is assigned to a set of execution pipes optimized for high-speed execution.

14. A processing system comprising:
a branch predictor;
a confidence mechanism coupled to said branch predictor to generate a confidence level signal for a corresponding branch prediction;
a critical path calculation unit coupled to said branch predictor to determine a set of dependencies for said branch prediction and whether said branch prediction is in a critical path of a set of instructions;
a scheduler coupled to said critical path calculation unit to organize said branch prediction and said set of dependencies for execution in a set of execution pipes associated with said confidence level, wherein said set of execution pipes includes:
a first set of execution pipelines optimized for low power consumption; and
a second set of execution pipelines optimized for fast execution.

15. The processing system of claim 14 wherein said confidence mechanism generates a binary signal for said confidence level signal.

16. The processing system of claim 15, wherein said first set of execution pipes executes said branch prediction with a high confidence level signal.

17. The processing system of claim 15 wherein said second set of execution pipes executes said branch prediction with a low confidence level signal.

18. A processing system comprising:
an external memory unit;
an instruction fetch unit coupled to said memory unit to fetch instructions from said memory unit;
a branch predictor coupled to said instruction fetch unit;
a confidence mechanism coupled to said branch predictor to generate a confidence level signal for a corresponding branch prediction;
a critical path calculation unit coupled to said branch predictor to determine a set of dependencies for said branch prediction and whether said branch prediction is in a critical path of a set of instructions;
a scheduler coupled to said critical path calculation unit to organize said branch prediction and said set of dependencies for execution in a set of execution pipes associated with said confidence level, wherein said set of execution pipes includes:
a first set of execution pipelines optimized for low power consumption; and
a second set of execution pipelines optimized for fast execution.

19. The processing system of claim 18 wherein said confidence mechanism generates a binary signal for said confidence level signal.

20. The processing system of claim 19 wherein said first set of execution pipes executes said branch prediction with a high confidence level signal.

21. The processing system of claim 19 wherein said second set of execution pipes executes said branch prediction with a low confidence level signal.

22. A set of instructions residing in a storage medium, said set of instructions capable of being executed by a processor to implement a method to execute a speculative instruction in a low power device of a processing system, the method comprising:
determining a confidence level for said speculative instruction; and
scheduling said speculative instruction for execution in said low power device.

23. The set of instructions of claim 22 wherein said confidence level is high.

24. The set of instructions of claim 23 wherein determining a confidence level for said speculative instruction includes generating a binary signal for attachment to said speculative instruction.

25. The set of instructions of claim 24 further comprising:
determining whether said speculative instruction is in a critical path of a set of instructions;
determining a set of dependent instructions for execution with said speculative instruction; and
executing said set of dependent instructions and said speculative instruction in said low power device.

26. The set of instructions of claim 25 wherein said low power device is an execution pipeline optimized for low power consumption.

27. The set of instructions of claim 26 wherein said speculative instruction is a branch prediction.

28. The set of instructions of claim 26 wherein said speculative instruction includes a data dependency.
